(19) United States
(12) Patent Application Publication
(10) Pub. No.: US 2024/0145803 A1
(43) Pub. Date: May 2, 2024

(54) METHOD AND SYSTEM FOR SEPARATING BLACK MASS FROM ELECTRODES OF SPENT LITHIUM ION BATTERIES

(71) Applicant: AGR LITHIUM INC., Bellevue, WA (US)

(72) Inventors: Vipin TYAGI, Bellevue, WA (US); Amol NAIK, Noida (IN); Nishchay CHADHA, Singapore (SG)

(73) Assignee: AGR LITHIUM INC., Bellevue, WA (US)

(21) Appl. No.: 18/385,004

(22) Filed: Oct. 30, 2023

Related U.S. Application Data
(60) Provisional application No. 63/420,959, filed on Oct. 31, 2022.

(51) Int. Cl. H01M 10/54; B03B 1/02; B03B 5/02; B03B 9/06

(52) U.S. Cl. CPC H01M 10/54; B03B 1/02; B03B 5/02; B03B 9/06; B03B 2009/066

(57) ABSTRACT

A method for separating black mass from electrodes of spent lithium ion batteries includes separating electrode pieces from remainder of material of a portion of a spent lithium ion battery. The electrode pieces are heated to a temperature in a range from about 200° C. to about 350° C. for a predetermined period of time to obtain pre-heated electrode pieces. The pre-heated electrode pieces are disposed in a neutral liquid to obtain a first suspension. Ultrasound vibrations are applied to the first suspension to separate the black mass and the binder from the metal pieces. Metal pieces, binder material and black mass from the electrode pieces are then segregated to obtain black mass.

### CROSS-REFERENCE TO RELATED APPLICATIONS

The present application claims to priority to U.S. Provisional Patent Application No. 63/420,959, filed on Oct. 31, 2022, the entirety of which is incorporated herein by reference for all purposes.

### FIELD

The present disclosure relates generally to the field of recycling of spent lithium ion batteries, and in particular to systems and methods for extraction of black mass from spent lithium ion batteries, and more particularly for separating black mass from electrodes of spent lithium ion batteries.

### BACKGROUND

The adoption of electric powered equipment such as automobile and power tools has grown rapidly over the past decade. Vast majority of the electric powered equipment use lithium-based batteries. Given the working life of lithium-based batteries, the number of spent lithium-based batteries is projected to grow exponentially in the coming years. Moreover, the amount of metals and other natural resources that are used as raw materials for lithium-based batteries is finite. Consequently, recycling of spent lithium-based batteries to recover valuable metals can become an important source for the raw materials. Additionally, because the materials used in lithium-batteries can cause pollution of water and other resources if left in landfills, recycling of spent lithium-based battery is also environmentally important. Development of economically viable methods of recycling the spent batteries is, therefore, necessary to keep the cost of the raw materials (and consequently, of the batteries) affordable and prevent pollution caused by the materials from spent lithium-based batteries.

The electrodes of lithium-based batteries are formed primarily of metals such as copper, iron and aluminum depending on the specific battery chemistry being used. Lithium-based batteries also include what is typically known as black mass, which generally includes graphite and salts of several valuable metals such as iron, cobalt, manganese, nickel, copper and aluminium (depending on the specific battery chemistry). The black mass also includes salts of lithium, which forms less than about 1% of the weight of the scrap battery, and typically less than about 2% of the weight of the active mass of the battery. The black mass for some of the novel battery chemistries may also include other metals, such as rare earths, in trace amounts.

One challenge when recovering black mass from spent lithium ion batteries is the PVDF binder that is used to bind the black mass from the electrode surface. As discussed herein, one of the approaches involves heating of electrodes at high temperature (e.g., greater than 600° C.-800° C.) to break PVDF bonds. However, heating any material above 500° C. results in deterioration of material properties. For example, heating metal electrodes in presence of metal salts may result in diffusion of metal ions from the metal salts into the metal electrode. Further during the process, the graphite present in the black mass along with lithium can be lost (e.g., through oxidation as carbon dioxide) and the remaining elements (Co, Ni) are recovered in form of alloys. For reusing these elements for various application, further more chemical operations are involved which involves high cost.

Consequently, current technologies for recycling spent batteries are not cost-effective relative to the technology for obtaining these materials anew. Cost-effective, low energy, sustainable, and low carbon-footprint technologies for recovering materials from spent batteries are, therefore, needed.

### SUMMARY

The embodiments disclosed herein stem from the realization that high temperature and/or pyrochemical techniques are not necessary for efficient separation of black mass from electrodes of a spent lithium ion battery. The present application discloses systems and methods for separating black mass from the electrodes spent lithium ion batteries using a combination of heat and ultrasound vibrations. Because the ultrasound vibrations used in the presently disclosed embodiments, when used in water can also produce heat, ultrasound vibrations can be utilized to reduce the time and energy required to separate black mass from the PVDF binder and the metal electrode pieces.

Pre-heated pieces of spent lithium ion battery, which can include metal, binder and black mass, are contacted with water and ultrasound vibrations are applied to the water and the pieces. Embodiments of the present disclosure utilize the realization that the combination of heating and ultrasound vibration separates the black mass from the binder and the metal electrode strips. Thus, advantageously, the embodiments disclosed herein enable extraction of black mass present in a lithium ion battery without having to use a pyrochemical process, thereby substantially reducing the time, cost and carbon footprint for recovery of metals from a lithium ion battery. The black mass can be then processed to extract salts of various valuable metals and may be processed further to obtain high purity valuable metals.

Accordingly, in at least one embodiment, a method of extracting black mass from a spent lithium-ion (Li-ion) battery includes separating electrode pieces from a remainder of material of a portion of a spent lithium ion battery. The electrode pieces include black mass, a binder material and metal pieces forming an electrode of the lithium ion battery. The method further includes heating the electrode pieces to a temperature in a range from about 200° C. to about 350° C. for a predetermined period of time to obtain pre-heated electrode pieces; and disposing the pre-heated electrode pieces in water to obtain a first suspension. Ultrasound vibrations are applied to the first suspension to separate the black mass and the binder material from the metal pieces. The metal pieces, the binder material and the black mass separated from the electrode pieces are then segregated.

In accordance with at least one embodiment, a system for recycling a spent Li-ion battery may include a crusher, a first separator, one or more heating chambers an ultrasound generator, a sonication chamber coupled to the ultrasound generator, a second separator, and a controller. The crusher is configured to break a cell of the spent Li-ion battery into pieces. The first separator is configured to segregate the pieces of the spent lithium ion battery into electrode pieces and a remainder of material. The electrode pieces include black mass, binder material and metal pieces. The one or more heating chambers are configured to heat the electrode pieces to a predetermined temperature for a predetermined period of time. The sonication chamber is configured to apply the ultrasound vibrations generated by the ultrasound generator to a first suspension of preheated electrode pieces in water. The second separator is configured to segregate the metal pieces the binder material and the black mass. The controller is configured to control a temperature in the one or more heating chambers. The controller is further configured control the ultrasound generator to control the frequency and intensity often ultrasound vibrations applied to the first suspension.

Additional features and advantages of the subject technology will be set forth in the description below, and in part will be apparent from the description, or may be learned by practice of the subject technology. The advantages of the subject technology will be realized and attained by the structure particularly pointed out in the written description and embodiments hereof as well as the appended drawings.

It is to be understood that both the foregoing general description and the following detailed description are exemplary and explanatory and are intended to provide further explanation of the subject technology.

### BRIEF DESCRIPTION OF THE DRAWINGS

Various features of illustrative embodiments of the present disclosure are described below with reference to the drawings. The illustrated embodiments are intended to illustrate, but not to limit, the present disclosure. The drawings contain the following figures:

FIG. 1 schematically shows an apparatus for recycling a spent lithium ion battery in accordance with at least some embodiments of the present disclosure.

FIG. 2 shows a flow chart for a method of extracting black mass from the electrodes of a spent lithium ion battery, in accordance with at least some embodiments of the present disclosure.

### DETAILED DESCRIPTION

In the following detailed description, numerous specific details are set forth to provide a full understanding of the subject technology. It should be understood that the subject technology may be practiced without some of these specific details. In other instances, well-known structures and techniques have not been shown in detail so as not to obscure the subject technology.

Further, while the present description sets forth specific details of various embodiments, it will be appreciated that the description is illustrative only and should not be construed in any way as limiting. Additionally, it is contemplated that although particular embodiments of the present disclosure may be disclosed or shown in the context of recycling certain types of lithium ion batteries, such embodiments can be used with all types of lithium ion batteries using modifications within the scope of the present disclosure and claims. Furthermore, various applications of such embodiments and modifications thereto, which may occur to those who are skilled in the art, are also encompassed by the general concepts described herein.

A typical lithium-ion battery, depending on the battery chemistry used, may contain graphite powder, and salts of one or more valuable metals such as lithium, aluminum, copper, cobalt, manganese, nickel, iron, and the like. Some of the commonly used lithium-ion battery types and the content of graphite and various metals in those battery types is provided in tables 1-6.

TABLE 1
Lithium Cobalt Oxide (LCO) batteries
LCO

| | |
|---|---|
| Components | % |

With Respect to Scrap

| | |
|---|---|
| Aluminum | 8.00% |
| Copper | 17.00% |
| Graphite (anode) | 16.00% |
| Active cathode material | 24.00% |

Compositions in Active Mass

| | |
|---|---|
| Lithium | 1.70% |
| Cobalt | 14.45% |
| Nickel | 0.00% |
| Aluminum | 0.00% |
| Oxygen | 7.85% |

Composition With Respect to Black Mass

| | |
|---|---|
| Al (foil particles) | 0.97% |
| Cu (foil particles) | 2.06% |
| Graphite | 38.79% |
| Lithium | 4.12% |
| Cobalt | 35.03% |
| Nickel | 0.00% |
| Aluminum | 0.00% |
| Oxygen | 19.03% |

Other Variables

| | |
|---|---|
| % of Al and Cu retained in black mass | 5.00% |

TABLE 2
Lithium Nickel Cobalt Aluminum (LNCA) batteries
LNCA

| | |
|---|---|
| Components | % |

With Respect to Scrap

| | |
|---|---|
| Aluminum | 8.00% |
| Copper | 17.00% |
| Graphite (anode) | 16.00% |
| Active cathode material | 24.00% |

Compositions in Active Mass

| | |
|---|---|
| Lithium | 1.73% |
| Cobalt | 2.20% |
| Nickel | 11.73% |
| Aluminum | 0.34% |
| Oxygen | 7.99% |

Composition With Respect to Black Mass

| | |
|---|---|
| Al (foil particles) | 0.97% |
| Cu (foil particles) | 2.06% |
| Graphite | 38.79% |
| Lithium | 4.19% |
| Cobalt | 5.33% |
| Nickel | 28.43% |
| Aluminum | 0.82% |
| Oxygen | 19.37% |

Other Variables

| | |
|---|---|
| % of Al and Cu retained in black mass | 5.00% |

TABLE 3
Nickel Manganese Cobalt ⅓ proportion
each in the active cathode (NMC111) batteries
NMC111

| | |
|---|---|
| Components | % |

With Respect to Scrap

| | |
|---|---|
| Aluminum | 8.00% |
| Copper | 17.00% |
| Graphite (anode) | 16.00% |
| Active cathode material | 24.00% |

Compositions in Active Mass

| | |
|---|---|
| Lithium | 1.73% |
| Cobalt | 4.89% |
| Nickel | 4.86% |
| Manganese | 4.56% |
| Oxygen | 7.96% |

Composition With Respect to Black Mass

| | |
|---|---|
| Al (foil particles) | 0.97% |
| Cu (foil particles) | 2.06% |
| Graphite | 38.79% |
| Lithium | 4.19% |
| Cobalt | 11.85% |
| Nickel | 11.78% |
| Manganese | 11.05% |
| Oxygen | 19.30% |

Other Variables

| | |
|---|---|
| % of Al and Cu retained in black mass | 5.00% |

TABLE 4
Nickel Manganese Cobalt 60/20/20% proportion
each in the active cathode (NMC622) batteries
NMC622

| | |
|---|---|
| Components | % |

With Respect to Scrap

| | |
|---|---|
| Aluminum | 8.00% |
| Copper | 17.00% |
| Graphite (anode) | 16.00% |
| Active cathode material | 24.00% |

Compositions in Active Mass

| | |
|---|---|
| Lithium | 1.72% |
| Cobalt | 2.92% |
| Nickel | 8.72% |
| Manganese | 2.72% |
| Oxygen | 7.92% |

Composition With Respect to Black Mass

| | |
|---|---|
| Al (foil particles) | 0.97% |
| Cu (foil particles) | 2.06% |
| Graphite | 38.79% |
| Lithium | 4.17% |
| Cobalt | 7.08% |
| Nickel | 21.14% |
| Manganese | 6.59% |
| Oxygen | 19.20% |

Other Variables

| | |
|---|---|
| % of Al and Cu retained in black mass | 5.00% |

TABLE 5
Nickel Manganese Cobalt 80/10/10% proportion
each in the active cathode (NMC811) batteries
NMC811

| | |
|---|---|
| Components | % |

With Respect to Scrap

| | |
|---|---|
| Aluminum | 8.00% |
| Copper | 17.00% |
| Graphite (anode) | 16.00% |
| Active cathode material | 24.00% |

Compositions in Active Mass

| | |
|---|---|
| Lithium | 1.71% |
| Cobalt | 1.46% |
| Nickel | 11.58% |
| Manganese | 1.36% |
| Oxygen | 7.89% |

Composition With Respect to Black Mass

| | |
|---|---|
| Al (foil particles) | 0.97% |
| Cu (foil particles) | 2.06% |
| Graphite | 38.79% |
| Lithium | 4.15% |
| Cobalt | 3.54% |
| Nickel | 28.07% |
| Manganese | 3.30% |
| Oxygen | 19.13% |

Other Variables

| | |
|---|---|
| % of Al and Cu retained in black mass | 5.00% |

TABLE 6
Lithium Iron Phosphate (LFP) batteries
LFP

| | |
|---|---|
| Components | % |

With Respect to Scrap

| | |
|---|---|
| Aluminum | 8.00% |
| Copper | 17.00% |
| Graphite (anode) | 15.30% |
| Active cathode material | 22.20% |

Compositions in Active Mass

| | |
|---|---|
| Lithium | 0.98% |
| Iron | 7.86% |
| Phosphorus | 4.35% |
| Oxygen | 9.00% |

Composition With Respect to Black Mass

| | |
|---|---|
| Al (foil particles) | 1.032% |
| Cu (foil particles) | 2.19% |
| Graphite | 39.48% |
| Lithium | 2.53% |
| Iron | 20.28% |
| Phosphorus | 11.23% |
| Oxygen | 23.23% |

Other Variables

| | |
|---|---|
| % of Al and Cu retained in black mass | 5.00% |

As evident from Tables 1-6, black mass, including graphite, forms a substantial portion of spent Li-ion batteries. The technology disclosed herein makes it possible to recover black mass from a spent Li-ion battery, thereby enabling recovery of graphite, valuable metals and valuable metal salts economically, sustainably, and at scale. The methods disclosed herein have low energy requirements, thereby reducing the carbon footprint of the recycling process. Further, the methods disclosed herein enable recovery of black mass from electrode pieces, and producing black mass-free electrode metal strips. The recovered black mass can then be further processed to extract valuable metals and valuable metal salts, which can advantageously be used directly in manufacturing Li-ion batteries instead of obtaining these materials de novo from other sources.

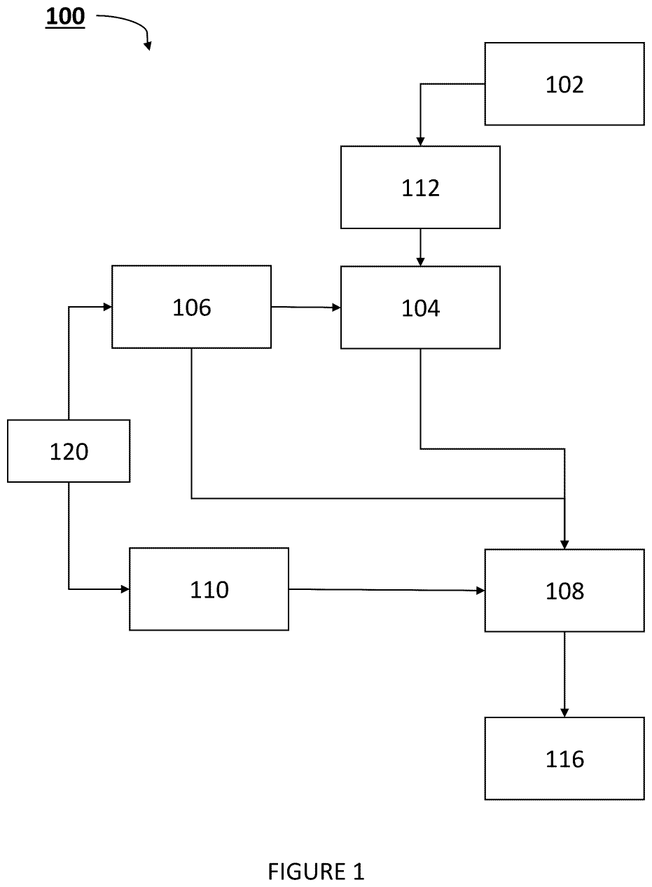

FIG. 1 shows a schematic diagram of an apparatus 100 for recycling a spent lithium ion battery in accordance with at least some embodiments of the present disclosure. In some embodiments, the apparatus 100 includes a crusher 102, one or more heating chambers 104, a heater 106 coupled to the heating chamber, a sonication chamber 108, an ultrasound generator 110 coupled to the sonication chamber 108, a controller 120 configured to control the heater 106 and ultrasound generator 110, a first separator 112 and a second separator 116.

In some embodiments, the crusher 102 is designed to break a cell of a spent lithium ion battery (also referred to herein as “spent battery” for convenient reference) into pieces having a dimension in a range from about 1 mm to about 5 cm. In some embodiments, the crusher 102 may include a chamber that can be sealed and evacuated to reduce the amount of oxygen in the chamber, thereby preventing oxidation of the pieces of the spent battery. In some embodiments, the chamber may be repressurized using an inert gas such as, for example, nitrogen or argon.

The first separator 112 is configured to segregate electrode pieces in the pieces of the spent battery from the remainder of materials of the spent battery. For example, the first separator 112 separates pieces of plastics, polymers, separators, and bulk black mass from the electrode pieces. In some embodiments, the first separator 112 may use techniques such as eddy current based sorting, spectral imaging base sorting, magnetic sorting, density separation, or a combination thereof. The electrode pieces separated in the first separator 112 are transferred to the one or more heating chambers 104 for further processing.

The one or more heating chambers 104, in some embodiments, are designed to heat the electrode pieces received from the first separator 112. The one or more heating chambers 104 may be coupled to a heater 106 configured to provide heat to the one or more heating chambers 104. In some embodiments, the one or more heating chambers may be configured to maintain an inert atmosphere, e.g., using nitrogen, argon and/or other inert gas(es). In some embodiments, the one or more heating chambers is configured to be maintained under vacuum. In some embodiments, the one or more heating chambers is configured to provide an oxidizing atmosphere. For example, in some embodiments, the one or more heating chambers may have higher oxygen partial pressure relative to atmosphere. In some embodiments, the one or more heating chambers may be evacuated and repressurized with substantially pure oxygen.

The heater 106 may be controlled using the controller 120, and may be configured to heat the electrode pieces in the one or more heating chambers to a temperature in a range from about 200° C. to about 350° C. For example, the electrode pieces may be heated to a temperature of about 200° C., about 210° C., about 220° C., about 230° C., about 240° C., about 250° C., about 260° C., about 270° C., about 280° C., about 290° C., about 300° C., about 310° C., about 320° C., about 330° C., about 340° C., about 350° C., or any temperature between any two of these values.

In some embodiments, the heater 106 is configured to provide sufficient heat to maintain the temperature of the electrode pieces in the one or more heating chambers in a range from about 200° C. to about 350° C. for a period of time ranging from about 30 minutes to about 120 minutes. For example, the temperature of the electrode pieces may be maintained for a period of about 30 minutes, about 40 minutes, about 50 minutes, about 60 minutes, about 70 minutes, about 80 minutes, about 90 minutes, about 100 minutes, about 110 minutes, about 120 minutes, or any amount of time between any two of these values.

The electrode pieces thus heated (also referred herein as “preheated electrode pieces”) may then be transferred to a sonication chamber 108. The sonication chamber 108 is coupled to an ultrasound generator 110 which is configured to provide ultrasound vibrations to the sonication chamber 108 (or the contents therein). In some embodiments, the sonication chamber 108 may also be coupled to the heater 106 so as to enable heating of the contents of the sonication chamber 108.

In some embodiments, the sonication chamber 108 is configured to receive a first suspension of electrode pieces in a neutral liquid. In some embodiments, the neutral liquid may include water, alcohol, dimethyl sulfoxide (DMSO), dimethylacetamide, N, N-dimethylformamide, or any other suitable liquid for suspending the electrode pieces therein. Thus, in some embodiments, the sonication chamber 108 may be coupled to a storage tank (not shown) which provides the suitable liquid using for suspending the electrode pieces to form the first suspension. In some embodiments, the suitable liquid may be deionized water. In some embodiments, the suitable liquid may be a solution of ethyl alcohol in water. In some embodiments, the suitable liquid may be mildly alkaline or mildly acidic. In some embodiments, the suitable liquid may be neutral, e.g., have a pH of about 7.

In some embodiments, water or the other suitable liquid is introduced in the sonication chamber 108 at room temperature. In some embodiments, water or the other suitable liquid is introduced in the sonication chamber 108 at a lower or an elevated temperature. For example, the temperature of water or the other suitable liquid introduced into the sonication chamber 108 may range from about 10° C. to about 100° C.

In some embodiments, the preheated electrode pieces are introduced into the sonication chamber 108 after the introduction of water or the other suitable liquid. In some embodiments, the preheated electrode pieces are introduced into the sonication chamber 108 simultaneously with water or the other suitable liquid. In some embodiments, the preheated electrode pieces are suspended in water or the other suitable liquid to form the first suspension in a separate chamber (not shown) and the first suspension then introduced into the sonication chamber 108. In such embodiments, the first suspension may be heated prior to introduction into the sonication chamber 108. Alternatively or additionally, the first suspension may be heated in the sonication chamber 108 to increase or maintain the temperature of the first suspension chamber.

The ultrasound generator 110 is coupled to the controller 120, which controls the frequency and/or the intensity of the ultrasound vibrations provided to the sonication chamber 108. In particular, the controller 120 may the amount of ultrasound energy received by the sonication chamber 108.

In some embodiments, the ultrasound vibrations received by the sonication chamber may have a frequency in range from about 25 kHz to about 100 kHz. For example, the ultrasound vibrations received by the sonication chamber 108 may have a frequency of about 25 kHz, about 30 kHz, about 35 kHz, about 40 kHz, about 45 kHz, about 50 kHz, about 55 kHz, about 60 kHz, about 65 kHz, about 70 kHz, about 75 kHz, about 80 kHz, about 85 kHz, about 90 kHz, about 95 kHz, about 100 kHz, or any other frequency between any two of these values.

In some embodiments, the ultrasound generator is controlled such that the first suspension receives an ultrasound energy at a rate ranging from about 10 W/kg to about 1000 kW/kg. For example, the ultrasound energy received by the first suspension may be at a rate of about 10 W/kg, about 50 W/kg, about 100 W/kg, about 200 W/kg, about 300 W/kg, about 400 W/kg, about 500 W/kg, about 750 W/kg, about 1000 W/kg, about, 1250 W/kg, about 1500 W/kg, about 2000 W/kg, about 5000 W/kg, about 10 kW/kg, about 20 kW/kg, about 30 kW/kg, about 40 kW/kg, about 50 kW/kg, about 60 kW/kg, about 70 kW/kg, about 100 kW/kg, about 125 kW/kg, about 150 kW/kg, about 200 kW/kg, about 300 kW/kg, about 400 kW/kg, about 500 kW/kg, about 600 kW/kg, about 700 kW/kg, about 800 kW/kg, about 900 kW/kg, about 1000 kW/kg, or any rate between any two of these values.

In some embodiments, the ultrasound vibrations are provided to the first suspension for a period of time ranging from about 10 minutes to about 100 minutes. For example, the ultrasound vibrations are provided to the first suspension for a period of about 10 minutes, about 20 minutes, about 30 minutes, about 40 minutes, about 50 minutes, about 60 minutes, about 70 minutes, about 80 minutes, about 90 minutes, about 100 minutes, or any amount of time between any two of these values.

The second separator 116 is configured to segregate the metal pieces, the binder material and the black mass resulting from the sonication of electrode pieces. In some embodiments, the second separator 116 may include a plurality of sieves of different sizes through with the first suspension is passed sequentially. In some embodiments, each of the plurality of sieves includes meshes of different mesh size. In some embodiments, the mesh size may range from about 5 mm to about 0.01 mm. For example, the plurality of sieves may have mesh size of about 5 mm, about 1 mm, about 500 μm, about 50 μm, about 10 μm, or any mesh size between any two of these size.

Upon passing through the second separator 116, solids in the first suspension are separated into electrode pieces (e.g., metal pieces such as copper pieces), pieces of black mass, black mass powder and graphite powder. The pieces of black mass may include graphite and salts of valuable metal.

Thus, in an aspect of the present disclosure, a suitable apparatus such as, for example, the apparatus 100, may be utilized for recycling spent batteries. In particular, in some embodiments, an apparatus such as apparatus 100 may be utilized for extracting black mass found in spent Li-ion batteries, and in particular from electrodes of spent Li-ion batteries. The black mass may be further processed to obtain graphite and salts of valuable metals such as, for example, salts of lithium, aluminum, copper, iron, nickel, cobalt and manganese.

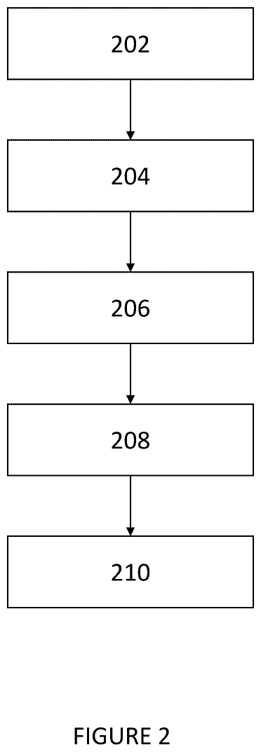

FIG. 2 illustrates a flow chart of a method 200 for extracting black mass from spent lithium ion batteries, and in particular from electrodes of lithium ion batteries, in accordance with at least some embodiments of the present disclosure. The method 200 may include, at 202, separating electrode pieces from remainder of material of a portion of a spent lithium ion battery, wherein the electrode pieces comprise black mass, metal pieces and a binder material. The electrode pieces are heated, at 204, to a temperature in a range from about 200° C. to about 350° C. using a suitable heating means to obtain preheated electrode pieces. At 206, the preheated electrode pieces are disposed in a neutral liquid to obtain a first suspension. At 208, ultrasound vibrations are applied to the first suspension to separate the black mass and the binder material from the metal pieces. At 210, the metal pieces, the binder material and the black mass are segregated.

In some embodiments, the electrode pieces from of the spent Li-ion battery are obtained by crushing a lithium ion battery. The process for obtaining the electrode pieces from the Li-ion battery may include, at 202, steps such as, for example, separation of the crushed portion via a sequence of segregating steps so as to separate material of different sizes. For example, in some embodiments, the separation may include separating coarse pieces having a size in a range from about 0.5 mm to about 5 mm by utilizing a suitable sieve, followed by further separating finer pieces having a size in a range from about 50 μm to about 0.5 mm by utilizing a second suitable sieve. In some embodiments, several (e.g., 3, 4, 5, 6, 7 or more) segregation steps may be performed using sieves of different mesh sizes.

In some embodiments, the separation step, at 202, may be performed in a first separator which can be sealed and evacuated to reduce the amount of oxygen in the chamber, thereby preventing oxidation of the pieces (including the electrode pieces) of the spent battery. In some embodiments, the chamber may be repressurized using an inert gas such as, for example, nitrogen or argon.

In some embodiment, the separation step, at 202, may include techniques such as eddy current based sorting, spectral imaging base sorting, magnetic sorting, density separation, or a combination thereof

The electrode pieces, may be introduced in one or more heating chambers, at 204, where the electrode pieces are heated to a suitable temperature. In some embodiments, the heating step may be performed in an inert atmosphere, e.g., using nitrogen, argon and/or other inert gas(es). In some embodiments, the heating step is performed under vacuum. In some embodiments, the heating step may be performed in an oxidizing atmosphere. For example, in some embodiments, the one or more heating chambers may have higher oxygen partial pressure relative to atmosphere. In some embodiments, the one or more heating chambers may be evacuated and repressurized with substantially pure oxygen.

In some embodiments, the suitable temperature may range from about 200° C. to about 350° C. For example, the electrode pieces may be heated to a temperature of about 200° C., about 210° C., about 220° C., about 230° C., about 240° C., about 250° C., about 260° C., about 270° C., about 280° C., about 290° C., about 300° C., about 310° C., about 320° C., about 330° C., about 340° C., about 350° C., or any temperature between any two of these values.

In some embodiments, the temperature of electrode pieces may be maintained at the suitable temperature for a period of time ranging from about 30 minutes to about 120 minutes. For example, the temperature of the electrode pieces may be maintained for a period of about 30 minutes, about 40 minutes, about 50 minutes, about 60 minutes, about 70 minutes, about 80 minutes, about 90 minutes, about 100 minutes, about 110 minutes, about 120 minutes, or any amount of time between any two of these values.

The preheated electrode pieces thus obtained may then be disposed, at 206, in a neutral liquid to obtain a first suspension. In some embodiments, the neutral liquid may include water, alcohol, dimethyl sulfoxide (DMSO), dimethylacetamide, N, N-dimethylformamide, or any other suitable liquid for suspending the electrode pieces therein. In some embodiments, the neutral liquid may be deionized water. In some embodiments, the suitable liquid may be a solution of ethyl alcohol in water. In some embodiments, the suitable liquid may be a solution of any one or more of dimethyl sulfoxide (DMSO), dimethylacetamide, or N, N-dimethylformamide in water. In some embodiments, the suitable liquid may be neutral, e.g., have a pH of about 7. In some embodiments, the instead of the neutral liquid, the liquid used for the first suspension may be mildly alkaline or mildly acidic.

At 208, ultrasound vibrations are applied to the first suspension, e.g., by applying ultrasound vibrations to a sonication chamber that contains the first suspension. The ultrasound vibrations may be generated using an ultrasound generator. The temperature of the first suspension may be maintained during the application of the ultrasound vibrations in some embodiments. In some embodiments, the first suspension may be at room temperature during the application of the ultrasound vibrations. In some embodiments, the first suspension may be at a lower or an elevated temperature during the ultrasound vibrations. For example, the temperature of the first suspension, may be maintained to be in a range from about 10° C. to about 100° C.

In some embodiments, the ultrasound vibrations applied at 208 may have a frequency in range from about 25 kHz to about 100 kHz. For example, the ultrasound vibrations applied at 208 may have a frequency of about 25 kHz, about 30 kHz, about 35 kHz, about 40 kHz, about 45 kHz, about 50 kHz, about 55 kHz, about 60 kHz, about 65 kHz, about 70 kHz, about 75 kHz, about 80 kHz, about 85 kHz, about 90 kHz, about 95 kHz, about 100 kHz, or any other frequency between any two of these values.

In some embodiments, the ultrasound generator is controlled such that the first suspension receives an ultrasound energy at a rate ranging from about 10 W/kg to about 1000 kW/kg. For example, the ultrasound energy received by the first suspension may be at a rate of about 10 W/kg, about 50 W/kg, about 100 W/kg, about 200 W/kg, about 300 W/kg, about 400 W/kg, about 500 W/kg, about 750 W/kg, about 1000 W/kg, about, 1250 W/kg, about 1500 W/kg, about 2000 W/kg, about 5000 W/kg, about 10 kW/kg, about 20 kW/kg, about 30 kW/kg, about 40 kW/kg, about 50 kW/kg, about 60 kW/kg, about 70 kW/kg, about 100 kW/kg, about 125 kW/kg, about 150 kW/kg, about 200 kW/kg, about 300 kW/kg, about 400 kW/kg, about 500 kW/kg, about 600 kW/kg, about 700 kW/kg, about 800 kW/kg, about 900 kW/kg, about 1000 kW/kg, or any rate between any two of these values.

In some embodiments, the ultrasound vibrations are applied to the first suspension for a period of time ranging from about 10 minutes to about 100 minutes. For example, the ultrasound vibrations are applied to the first suspension for a period of about 10 minutes, about 20 minutes, about 30 minutes, about 40 minutes, about 50 minutes, about 60 minutes, about 70 minutes, about 80 minutes, about 90 minutes, about 100 minutes, or any amount of time between any two of these values.

Upon applying the ultrasound vibrations for a predetermined period of time, the black mass and the binder material is separated from the metal pieces. Then, at 210, the metal pieces, the black mass, and the binder material are segregated, e.g., in a second separator.

The segregation step at 210 may include sequentially passing the first suspension through a plurality of sieves of different sizes. In some embodiments, each of the plurality of sieves includes meshes of different mesh size. In some embodiments, the mesh size may range from about 5 mm to about 0.01 mm. For example, the plurality of sieves may have mesh size of about 5 mm, about 1 mm, about 500 μm, about 50 μm, about 10 μm, or any mesh size between any two of these size.

In some embodiments, the sieves may be designed or selected to enable separation of solid matter having different sizes. For example, the a first sieve may separate solid matter having a size greater than about 5 mm; a second sieve may separate solid matter having a size in a range from about 5 mm to about 1 mm; a third sieve may separate solid matter having a size in a range from about 1 mm to about 0.5 mm; a fourth sieve may separate solid matter having a size in a range from about 500 μm to about 100 μm; a fifth sieve may separate solid matter having a size in a range from about 100 μm to about 50 μm; a sixth mesh, filter or sieve may separate solid matter having a size in a range from about 50 μm to about 10 μm; and so forth.

The black mass obtained at 210 may be further processed to obtain graphite and salts of valuable metals. In addition, the metal pieces obtained at 210 may be further processed to obtain pure metal pieces which may then be reused for making battery electrodes.

Thus, the present disclosure provides a system and method for obtaining black mass including graphite and metal salts from electrodes of spent lithium ion batteries. Advantageously, the graphite powder so obtained via the process disclosed herein already meets the specifications for use in lithium-based batteries. Consequently, the graphite powder obtained via the process disclosed herein may be utilized as-is for manufacturing of lithium-based batteries. Further advantageously, the systems and methods described herein can provide metal pieces free of organic matter, and can, therefore, be further processed to obtain pure metal pieces which can be reused for manufacturing battery electrode.

The method disclosed herein is performed at a relatively low temperature, and does not require smelting or other high temperature processes. Consequently, no gases are emitted gases and the process is essentially a zero-pollution process.

### Further Considerations

In some embodiments, any of the clauses herein may depend from any one of the independent clauses or any one of the dependent clauses. In one aspect, any of the clauses (e.g., dependent or independent clauses) may be combined with any other one or more clauses (e.g., dependent or independent clauses). In one aspect, a claim may include some or all of the words (e.g., steps, operations, means or components) recited in a clause, a sentence, a phrase or a paragraph. In one aspect, a claim may include some or all of the words recited in one or more clauses, sentences, phrases or paragraphs. In one aspect, some of the words in each of the clauses, sentences, phrases or paragraphs may be removed. In one aspect, additional words or elements may be added to a clause, a sentence, a phrase or a paragraph. In one aspect, the subject technology may be implemented without utilizing some of the components, elements, functions or operations described herein. In one aspect, the subject technology may be implemented utilizing additional components, elements, functions or operations.

The subject technology is illustrated, for example, according to various aspects described below. Various examples of aspects of the subject technology are described as numbered clauses (1, 2, 3, etc.) for convenience. These are provided as examples and do not limit the subject technology. It is noted that any of the dependent clauses may be combined in any combination, and placed into a respective independent clause, e.g., clause 1 or clause 5. The other clauses can be presented in a similar manner.

Clause 1. A method comprising: separating electrode pieces from remainder of material of a portion of a spent lithium ion battery, wherein the electrode pieces comprise black mass, metal pieces and a binder material; heating the electrode pieces to a temperature in a range from about 200° C. to about 350° C. for a predetermined period of time to obtain pre-heated electrode pieces; disposing the pre-heated electrode pieces in a neutral liquid obtain a first suspension; applying ultrasound vibrations to the first suspension to separate the black mass and the binder material from the metal pieces; and segregating the metal pieces, the binder material and the black mass.

Clause 2. The method of clause 1, wherein the predetermined time period of time is in a range from about 30 minutes to about 120 minutes.

Clause 3. The method of clause 1, wherein the ultrasound vibrations have a frequency in a range from about 25 kHz to about 100 kHz.

Clause 4. The method of clause 1, wherein applying the ultrasound vibrations comprises applying the ultrasound vibrations for a period of time in a range from about 10 minutes to about 100 minutes.

Clause 5. The method of clause 1, wherein heating the electrode pieces comprises heating the electrode pieces in a vacuum.

Clause 6. The method of clause 1, wherein heating the electrode pieces comprises heating the electrode pieces in presence of an inert gas.

Clause 7. The method of clause 1, wherein the neutral liquid in which the pre-heated electrode pieces are disposed has a temperature in a range from about 10° C. to about 100° C.

Clause 8. The method of clause 1, wherein the neutral liquid has a pH of about 7.

Clause 9. The method of clause 1, wherein the neutral liquid comprises one or more selected from the group consisting of deionized water, dimethyl sulfoxide (DMSO), dimethylacetamide, and N, N-dimethylformamide.

Clause 10. The method of clause 1, wherein applying the ultrasound vibrations to the first suspension comprises applying ultrasound energy in a range from about 10 W to about 100 kW per kg of the first suspension, or in a range from about 50 W to about 1000 W per kg of the first suspension, or in a range from about 100 W to about 500 W per kg of the first suspension, or in a range from about 1 kW to about 5 kW per kg of the first suspension, or in a range from about 5 kW to about 10 kW per kg of the first suspension, or in a range from about 10 kW to about 50 kW per kg of the first suspension, or in a range from about 50 kW to about 100 kW per kg of the first suspension.

Clause 11. The method of clause 1, further comprising heating and/or maintaining a temperature of the first suspension to be in a range from about 10° C. to about 100° C.

Clause 12. The method of clause 11, wherein maintaining the temperature of the first suspension is for a duration for which ultrasound vibrations are applied.

Clause 13. The method of clause 1, wherein segregating the metal pieces, the binder material and the black mass comprises sequentially passing the first suspension through one or more sieves of different sizes.

Clause 14. The method of clause 13, wherein the one or more sieves have a mesh size in a range from about 5 mm to about 0.01 mm.

Clause 15. The method of clause 14, further comprising drying a remainder undissolved material after passing the first suspension through a sieve having the smallest mesh size to obtain a graphite powder.

Clause 16. The method of clause 1, wherein the remainder of material of a portion of the spent lithium ion battery comprises pieces of one or more of plastics, metal separator, polymer separator, and electrolyte.

Clause 17. A system for recycling a spent lithium ion battery, the system comprising: a crusher configured to break a cell of the spent lithium ion battery into pieces; a first separator configured to segregate the pieces of the spent lithium ion battery into electrode pieces and a remainder of material, the electrode pieces comprise black mass, metal pieces and a binder material; one or more heating chambers configured to heat the electrode pieces to a predetermined temperature for a predetermined period of time; a sonication chamber coupled to an ultrasound generator, the sonication chamber being configured to apply ultrasound vibrations, generated by the ultrasound generator, to a first suspension of preheated electrode pieces in a neutral liquid; a second separator configured to segregate the metal pieces, the binder material and the black mass; and a controller configured to: control a temperature in the one or more heating chambers, and control an ultrasound generator coupled to the sonication chamber to control application of the ultrasound vibrations.

Clause 18. The system of clause 17, further comprising a mixing chamber configured to mix preheated electrode pieces with the neutral liquid to obtain the first suspension.

Clause 19. The system of clause 17, wherein the controller is configured to control frequency and intensity of ultrasound vibrations applied to the sonication chamber, and control an amount of time for which the ultrasound vibrations are applied.

Clause 20. The system of clause 17, wherein the one or more heating chambers are configured to be maintained under vacuum and/or have an inert atmosphere.

Clause 21. The system of clause 17, wherein the crusher is configured to be maintained under vacuum and/or have an inert atmosphere.

Clause 22. The system of clause 17, wherein the predetermined temperature is in a range from about 200° C. to about 350° C.

Clause 23. The system of clause 17, wherein the predetermined period of time is in a range from 30 minutes to about 120 minutes.

Clause 24. The system of clause 17, wherein the ultrasound vibrations have a frequency in a range from about 25 kHz to about 100 kHz.

Clause 25. The system of clause 17, wherein the ultrasound vibrations are applied to the first suspension for a period of time in a range from about 10 minutes to about 100 minutes.

Clause 26. The system of clause 17, wherein the ultrasound vibrations have an energy in a range from about 10W to about 100 kW per kg of the first suspension, or in a range from about 50 W to about 1000 W per kg of the first suspension, or in a range from about 100 W to about 500 W per kg of the first suspension, or in a range from about 1 kW to about 5 kW per kg of the first suspension, or in a range from about 5 kW to about 10 kW per kg of the first suspension, or in a range from about 10 kW to about 50 kW per kg of the first suspension, or in a range from about 50 kW to about 100 kW per kg of the first suspension.

Clause 27. The system of clause 17, further comprising a heater coupled to the sonication chamber, the heater being configured to increase and/or maintain a temperature of the first suspension to a temperature in a range from about 10° C. to about 100° C.

Clause 28. The system of clause 27, wherein the temperature of the first suspension is maintained for a period of time in a range from about 10 minutes to about 100 minutes.

Clause 29. The system of clause 17, wherein the second separator is configured to segregate the metal pieces, the binder material and the black mass by sequentially passing the first suspension through one or more sieves of different sizes.

Clause 30. The system of clause 29, wherein the one or more sieves have a mesh size in a range from about 5 mm to about 0.01 mm.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

As used herein, the term “about” preceding a quantity indicates a variance from the quantity. The variance may be caused by manufacturing tolerances or may be based on differences in measurement techniques. The variance may be up to 10% from the listed value in some instances. Those of ordinary skill in the art would appreciate that the variance in a particular quantity may be context dependent and thus, for example, the variance in a dimension at a micro or a nano scale may be different than variance at a meter scale.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A method comprising:
separating electrode pieces from remainder of material of a portion of a spent lithium ion battery, wherein the electrode pieces comprise black mass, metal pieces and a binder material;
heating the electrode pieces to a temperature in a range from about 200° C. to about 350° C. for a predetermined period of time to obtain pre-heated electrode pieces;
disposing the pre-heated electrode pieces in a neutral liquid obtain a first suspension;
applying ultrasound vibrations to the first suspension to separate the black mass and the binder material from the metal pieces; and
segregating the metal pieces, the binder material and the black mass.

2. The method of claim 1, wherein the predetermined time period of time is in a range from about 30 minutes to about 120 minutes.

3. The method of claim 1, wherein the ultrasound vibrations have a frequency in a range from about 25 kHz to about 100 kHz.

4. The method of claim 1, wherein applying the ultrasound vibrations comprises applying the ultrasound vibrations for a period of time in a range from about 10 minutes to about 100 minutes.

5. The method of claim 1, wherein heating the electrode pieces comprises heating the electrode pieces in a vacuum.

6. The method of claim 1, wherein heating the electrode pieces comprises heating the electrode pieces in presence of an inert gas.

7. The method of claim 1, wherein the neutral liquid in which the pre-heated electrode pieces are disposed has a temperature in a range from about 10° C. to about 100° C.

8. The method of claim 1, wherein the neutral liquid has a pH of about 7.

9. The method of claim 1, wherein the neutral liquid comprises one or more selected from the group consisting of deionized water, dimethyl sulfoxide (DMSO), dimethylacetamide, and N, N-dimethylformamide.

10. The method of claim 1, wherein applying the ultrasound vibrations to the first suspension comprises applying ultrasound energy in a range from about 10 W to about 100 kW per kg of the first suspension, or in a range from about 50 W to about 1000 W per kg of the first suspension, or in a range from about 100 W to about 500 W per kg of the first suspension, or in a range from about 1 kW to about 5 kW per kg of the first suspension, or in a range from about 5 kW to about 10 kW per kg of the first suspension, or in a range from about 10 kW to about 50 kW per kg of the first suspension, or in a range from about 50 kW to about 100 kW per kg of the first suspension.

11. The method of claim 1, further comprising heating and/or maintaining a temperature of the first suspension to be in a range from about 10° C. to about 100° C.

12. The method of claim 11, wherein maintaining the temperature of the first suspension is for a duration for which ultrasound vibrations are applied.

13. The method of claim 1, wherein segregating the metal pieces, the binder material and the black mass comprises sequentially passing the first suspension through one or more sieves of different sizes.

14. The method of claim 13, wherein the one or more sieves have a mesh size in a range from about 5 mm to about 0.01 mm.

15. The method of claim 14, further comprising drying a remainder undissolved material after passing the first suspension through a sieve having the smallest mesh size to obtain a graphite powder.

16. The method of claim 1, wherein the remainder of material of a portion of the spent lithium ion battery comprises pieces of one or more of plastics, metal separator, polymer separator, and electrolyte.

17. A system for recycling a spent lithium ion battery, the system comprising:
a crusher configured to break a cell of the spent lithium ion battery into pieces;
a first separator configured to segregate the pieces of the spent lithium ion battery into electrode pieces and a remainder of material, the electrode pieces comprise black mass, metal pieces and a binder material;
one or more heating chambers configured to heat the electrode pieces to a predetermined temperature for a predetermined period of time;
a sonication chamber coupled to an ultrasound generator, the sonication chamber being configured to apply ultrasound vibrations, generated by the ultrasound generator, to a first suspension of preheated electrode pieces in a neutral liquid;
a second separator configured to segregate the metal pieces, the binder material and the black mass; and
a controller configured to:
control a temperature in the one or more heating chambers, and
control an ultrasound generator coupled to the sonication chamber to control application of the ultrasound vibrations.

18. The system of claim 17, further comprising a mixing chamber configured to mix preheated electrode pieces with the neutral liquid to obtain the first suspension.

19. The system of claim 17, wherein the controller is configured to control frequency and intensity of ultrasound vibrations applied to the sonication chamber, and control an amount of time for which the ultrasound vibrations are applied.

20. The system of claim 17, wherein the one or more heating chambers are configured to be maintained under vacuum and/or have an inert atmosphere.

21. The system of claim 17, wherein the crusher is configured to be maintained under vacuum and/or have an inert atmosphere.

22. The system of claim 17, wherein the predetermined temperature is in a range from about 200° C. to about 350° C.

23. The system of claim 17, wherein the predetermined period of time is in a range from 30 minutes to about 120 minutes.

24. The system of claim 17, wherein the ultrasound vibrations have a frequency in a range from about 25 kHz to about 100 kHz.

25. The system of claim 17, wherein the ultrasound vibrations are applied to the first suspension for a period of time in a range from about 10 minutes to about 100 minutes.

26. The system of claim 17, wherein the ultrasound vibrations have an energy in a range from about 10 W to about 100 kW per kg of the first suspension, or in a range from about 50 W to about 1000 W per kg of the first suspension, or in a range from about 100 W to about 500 W per kg of the first suspension, or in a range from about 1 kW to about 5 kW per kg of the first suspension, or in a range from about 5 kW to about 10 kW per kg of the first suspension, or in a range from about 10 kW to about 50 kW per kg of the first suspension, or in a range from about 50 kW to about 100 kW per kg of the first suspension.

27. The system of claim 17, further comprising a heater coupled to the sonication chamber, the heater being configured to increase and/or maintain a temperature of the first suspension to a temperature in a range from about 10° C. to about 100° C.

28. The system of claim 27, wherein the temperature of the first suspension is maintained for a period of time in a range from about 10 minutes to about 100 minutes.

29. The system of claim 17, wherein the second separator is configured to segregate the metal pieces, the binder material and the black mass by sequentially passing the first suspension through one or more sieves of different sizes.

30. The system of claim 29, wherein the one or more sieves have a mesh size in a range from about 5 mm to about 0.01 mm.
